(19) United States
(12) Patent Application Publication
(10) Pub. No.: US 2026/0269298 A1
(43) Pub. Date: Sep. 10, 2026

(54) MANIFOLD FOR A FUEL CELL

(71) Applicant: SAFRAN POWER UNITS, TOULOUSE (FR)

(72) Inventors: Jean-Yves Robert BIDAULT, MOISSY-CRAMAYEL (FR); Remy Thomas SALVATGE, MOISSY-CRAMAYEL (FR); Romain Alexandre DAULIAC, MOISSY-CRAMAYEL (FR); Michel Adrien MOLLIER, TOULOUSE (FR)

(73) Assignee: SAFRAN POWER UNITS, TOULOUSE (FR)

(21) Appl. No.: 19/489,304

(22) PCT Filed: Jun. 8, 2024
(86) PCT No.: PCT/EP2024/065841

§ 371 Date: Dec. 2, 2025

(30) Foreign Application Priority Data
Jun. 14, 2023 (FR) FR2306088

(51) Int. Cl. H01M 8/2485; H01M 8/04082; H01M 8/2404; H01M 8/2457; H01M 8/249

(52) U.S. Cl. CPC H01M 8/2485; H01M 8/04201; H01M 8/2404; H01M 8/2457; H01M 8/249; H01M 2250/20

(57) ABSTRACT

The invention relates to a manifold (9) for a fuel cell configured to be supplied with an air flow (FA) and with a hydrogen flow (FH), the fuel cell comprising at least two stacks (EI-ES), each stack (EI-ES) comprising a plurality of electrochemical cells, the manifold (9) extending longitudinally along a manifold axis (XC) and vertically along a vertical axis (Z), the manifold (9) defining a body (90) comprising a first lateral face (FI) configured to interface with at least one stack (EI-E4) and a second lateral face (F2) configured to interface with at least one stack (E5-E8), the manifold (9) comprising a connection face (F3) comprising a first hydrogen connector (91a) configured to supply the at least one stack (EI-E4) from the first lateral face (FI) and a first air connector (92a) configured to supply the at least one stack (EI-E4) from the first lateral face (FI).

### TECHNICAL FIELD

The climate change is a major concern for many legislative and regulatory members around the world. In fact, various restrictions on carbon emissions have been, are being or will be adopted by different countries. In particular, an ambitious standard applies both to new airplane types and to those already in circulation, requiring the implementation of technological solutions to bring them into line with current regulations. The civil aviation industry has been mobilizing for several years now to make a contribution to the fight against climate change.

The technological research efforts have already led to significant improvements in the environmental performance of airplanes. The Applicant takes into account the impacting factors in all phases of design and development to obtain aeronautical components and products that consume less energy, are more respectful of the environment and whose integration and use in civil aviation have moderate environmental consequences with the aim of improving the energy efficiency of airplanes.

Consequently, the Applicant is constantly working to reduce its negative impact on the climate through the use of virtuous development and the manufacturing methods and processes that minimize the greenhouse gas emissions to the minimum possible in order to reduce the environmental footprint of its activity.

This ongoing research and development work focuses on the new generations of aircraft engines, making the apparatus lighter, particularly through the use of lighter materials and onboard equipment, developing the use of electric technologies for propulsion, and, as an essential complement to technological progress, the aeronautical biofuels.

It has thus been proposed to equip an aircraft with a plurality of propelling electric motors to enable the aircraft to be propelled. In a known way, the aircraft comprises at least one fuel cell to electrically power a plurality of propelling electric motors. In practice, depending on the aircraft's flight phase (take-off, cruise, cab, etc.), the power required by the propelling electric motors is different, which translates into a variable electrical load for the fuel cell. In order to provide a variable electrical load, it is known to use several fuel cells associated with an electronic power regulation device to meet the aircraft's needs while maintaining the fuel cells in a high-efficiency operating range. The integration of an electronic power regulation device significantly increases the volume and the weight, which is particularly penalizing in an aeronautical context. In practice, obtaining fuel cells that meet exact requirements is complex, and oversized fuel cells are generally used, which penalizes mass and size.

The invention thus aims to eliminate at least some of these disadvantages.

### SUMMARY

The invention relates to a manifold for a fuel cell configured to be supplied with an air flow and with a hydrogen flow, the fuel cell comprising at least two stacks, each stack comprising a plurality of electrochemical cells, the manifold extending longitudinally along a manifold axis and vertically along a vertical axis, the manifold defining a body comprising a first lateral face configured to interface with at least one stack and a second lateral face configured to interface with at least one stack, the manifold comprising a connection face comprising:
a first hydrogen connector configured to supply said at least one stack from the first lateral face,
a first air connector configured to supply said at least one stack from the first lateral face.

Thanks to the invention, such a manifold enables several stacks to be spatially distributed to increase compactness and reduce the overall dimensions.

According one aspect, the hydrogen connectors are located vertically above the air connectors. This allows avoiding any mixing of fluids and facilitates the treatment of any leaks.

According to one aspect, each lateral face is connected to a common end plate to which all the stacks interfaced with said lateral face are connected. The use of a common end plate reduces leakage paths and increases structural strength.

According to one aspect, the common end plate is removably connected to said lateral face. The use of a common end plate enables maintenance of a large number of stacks.

According to one aspect, each stack interfaced with a lateral face is independently connected to the common end plate associated with said lateral face. Thus, a single stack may be removed for maintenance, providing great flexibility.

According to one aspect, each stack interfaced with said lateral face comprises a personal end plate connected to the common end plate by a plurality of traction members. A single stack may be removed by removing its personal end plate.

According to one aspect, the first lateral face and the second lateral face are inclined with respect to each other by a spread angle so that the body of the manifold is flared at the lower part. This allows the collection of water from the stacks in the manifold while reducing the overall dimensions.

The invention also relates to a fuel cell comprising a manifold as previously presented configured to be supplied by the air flow and the hydrogen flow and at least two stacks connected to the manifold, each stack comprising a plurality of electrochemical cells.

According to one aspect, the maintenance method includes a step of removing a common end plate from the body of the manifold, with all the stacks supplied by the lateral face associated with the common end plate remaining secured to the common end plate.

According to one aspect, the maintenance method comprises the steps of:
Removing a personal end plate from a stack,
Removing the stack from a common end plate,
Placing a new stack on the common end plate,
Replacing the personal end plate on the new stack.

Also disclosed is a power supply system for at least one aircraft propelling electric motor, the power supply system comprising a fuel cell, configured to be supplied by an air flow and by a hydrogen flow, configured to electrically supply an electrical distribution unit configured to be connected to said propelling electric motor.

The system is remarkable in that the fuel cell comprises at least a first electrochemical line and a second electrochemical line electrically connected in parallel, each electrochemical line comprising at least two independent stacks electrically connected in series, each stack comprising a plurality of electrochemical cells.

There is great flexibility in the choice of stacks, and there is no need to use a fuel cell comprising a single stack that is oversized in terms of power, which increases weight and bulk. The modular design of the fuel cell also allows a precise positioning of the center of gravity, thereby increasing stability and optimizing the overall dimensions. The use of several independent stacks facilitates maintenance while enabling high voltage levels to be achieved.

According to one aspect, the power supply system comprises a single fuel cell. The use of a single fuel cell allows for a reduction in the overall dimensions and eliminates the need for an electronic power regulation device.

Preferably, each electrochemical line comprises three or four independent stacks electrically connected in series. Such an electrochemical line offers considerable flexibility in terms of maintenance and space requirements, while keeping complexity to a minimum.

Preferably, the fuel cell comprises only a first electrochemical line and a second electrochemical line connected electrically in parallel. This allows for flexibility and redundancy.

According to one aspect, the electrical distribution unit does not include a power regulation device. This allows the power generation system to be simplified while reducing weight and size.

According to one aspect, the power supply system comprises an air supply circuit configured to supply the fuel cell with an air flow, the air supply circuit comprising an upstream air inlet. The air flow flows from upstream to downstream.

According to one aspect, the electrical distribution unit is positioned upstream of the fuel cell. This allows it to be kept away from the fuel cell connectors located downstream.

According to one aspect, the air supply circuit comprises an air circulation pump positioned vertically beneath the fuel cell.

According to one aspect, the fuel cell comprises an upper part comprising at least one hydrogen connector and a lower part comprising at least one air connector. This allows optimizing the overall dimensions while enabling segregation between air (in the lower part) and hydrogen (in the upper part) by taking advantage of the fact that air is heavier than hydrogen.

According to one aspect, the power supply system comprises a support structure having a lattice shape defining a main housing in which the fuel cell is mounted. This allows the fuel cell to be ventilated while providing optimal protection against shocks.

According to one aspect, the power supply system comprises an auxiliary electrical box configured to power the air circulation pump and, preferably, a cooling circulation pump.

According to one aspect, the fuel cell comprises a manifold configured to be supplier by the air flow and by the hydrogen flow, the manifold being connected to the two electrochemical lines. This allows simplifying the structure of the fuel cell.

The manifold also makes for greater compactness, while reducing the mass of the electrochemical lines as a whole. The manifold also reduces the number and the size of possible hydrogen leak paths. The stacks may also be optimally inclined during their operation.

According to one aspect, each electrochemical line is configured to be independently powered. Thus, this allows the power generated by each electrochemical line to be regulated independently.

Also shown is an assembly comprising a supply system, as described above, and at least one aircraft propelling electric motor connected to the electrical distribution unit. According to one aspect, the aircraft propelling electric motor is connected directly to the electrical distribution unit. Thus, there is no need to use an electronic power regulation device.

Also shown is an aircraft comprising at least one assembly, as previously shown, to enable propulsion of said aircraft.

Also presented is a method of supplying electrical power to at least one aircraft propelling electric motor connected to a power supply system, as presented above, the method comprising steps consisting of:
supplying the fuel cell with an air flow and a hydrogen flow to electrically power the electrical distribution unit connected to said propelling electric motor, and
regulating at least the air flow in each electrochemical line to regulate the electrical power supplied by the fuel cell.

### BRIEF DESCRIPTION OF THE DRAWINGS

The invention will be better understood on reading the following description, which is given by way of example, with reference to the following figures, given as non-limiting examples, in which identical references are given to similar objects.

FIG. 1 is a schematic representation of an aircraft comprising propelling electric motors powered by the power supply systems.

FIG. 2 is a schematic representation of a power supply system according to the invention.

FIG. 3, FIG. 4 and FIG. 5 are perspective, upstream and side views, respectively, of a power supply system according to one embodiment of the invention.

FIG. 6 is a schematic representation of the fuel cell with a manifold and stacks in assembled position.

FIG. 7 is a schematic representation of the architecture of the fuel cell.

FIG. 8 is a schematic representation of the fuel cell of FIG. 6 after removal of a single stack.

FIG. 9 is a schematic representation of the fuel cell of FIG. 6 after removing a common end plate connected to several stacks.

It should be noted that the figures set out the invention in detail in order to implement the invention, said figures of course being able to be used to better define the invention where appropriate.

### DETAILED DESCRIPTION

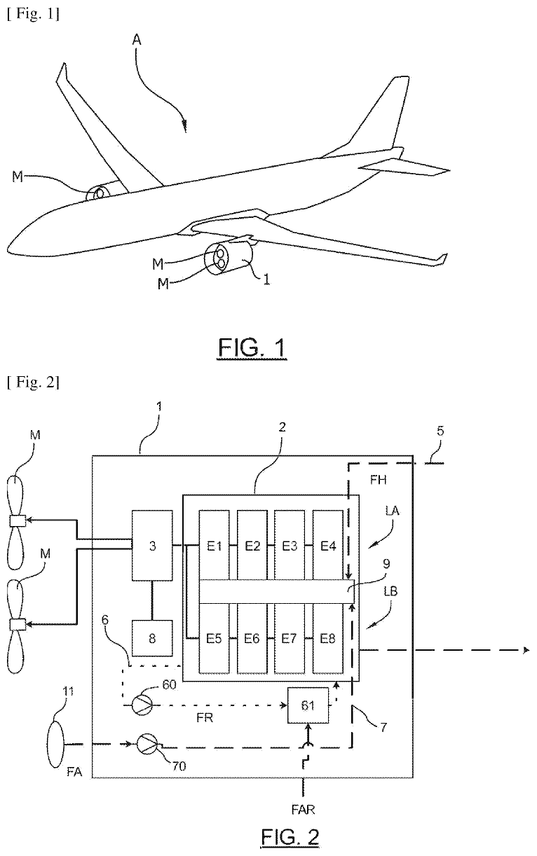

With reference to FIG. 1, an aircraft A is presented, comprising several propelling electric motors M to allow its propulsion. The aircraft A also comprises two power supply systems 1 according to the invention, each for powering several propelling electric motors M.

It goes without saying that the invention may be applied to any type of aircraft, with a single engine, with two engines, or with a large number of distributed engines. The invention applies equally well to airplanes, helicopters and vertical take-off and landing aircraft.

In this example, the propelling electric motors M are positioned in the immediate vicinity of the power supply system 1 with which they are associated, in order to limit electrical losses. It goes without saying that a power supply system 1 could power only one propelling electric motor M. In this example, the power supply systems 1 are positioned under the lateral wings of the aircraft A, but it goes without saying that their positioning could be different.

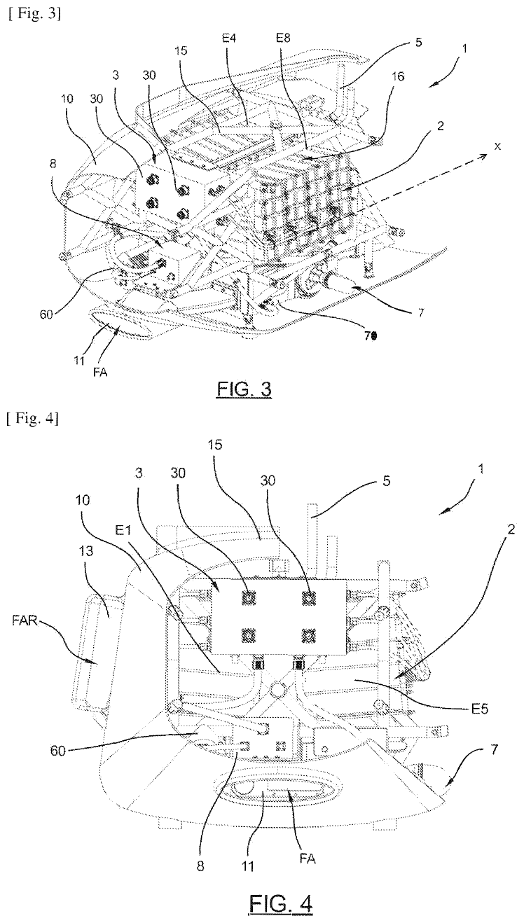

With reference to FIG. 3, a power supply system 1 according to one embodiment of the invention is shown. The power supply system 1 is mounted in an enclosure 10, also referred to as a “nacelle”, extending along a longitudinal axis X oriented from upstream to downstream. In FIG. 3, the enclosure 10 is open upstream to accommodate one or more propelling electric motors M (shown in FIG. 3).

In this example, with reference to FIGS. 3 to 5, the power supply system 1 comprises a single fuel cell 2 that electrically powers an electrical distribution unit 3 configured to be connected directly to the propelling electric motors M. The power supply system 1 comprises a support structure 15 in the form of a lattice defining a main housing 16 in which the fuel cell 2 is mounted. The lattice structure comprises several tubes that are assembled to form meshes, in particular, rectangular in shape. In this way, the fuel cell 2 is protected from mechanical impact, stably supported and adequately ventilated.

As is known, the fuel cell 2 allows generating electrical energy from an electrochemical reaction. Typically, different fluids flow through the fuel cell 2 to react with each other and generate electrical energy. In particular, such a reaction may be a redox reaction between dioxygen and dihydrogen. The fuel cell 2 is thus supplied with dioxygen and dihydrogen. The redox reaction also generates water, which is discharged from the fuel cell 2. In this example, with reference to FIG. 2, as will be shown later, the power supply system 1 comprises an air supply circuit 7 for supplying an air flow FA comprising dioxygen to the fuel cell 2 and a hydrogen supply circuit 5 for supplying a hydrogen flow FH to the fuel cell 2.

In this example, the fuel cell 2 is a high-temperature cell in which the water generated by the reaction is in vapor form. In fact, the water in the form of steam is easily removed. It goes without saying that the invention also applies to a low-temperature fuel cell 2.

The fuel cell 2 is also supplied with cooling fluid FR to remove the heat generated by the electrochemical reaction. Such a cooling fluid FR is a heat transfer fluid, such as oil or water, which may be mixed with additives. In this example, with reference to FIG. 2, the power supply system 1 includes a cooling circuit 6 as will be shown later.

With reference to FIG. 2, the power supply system 1 of FIG. 3 is shown schematically.

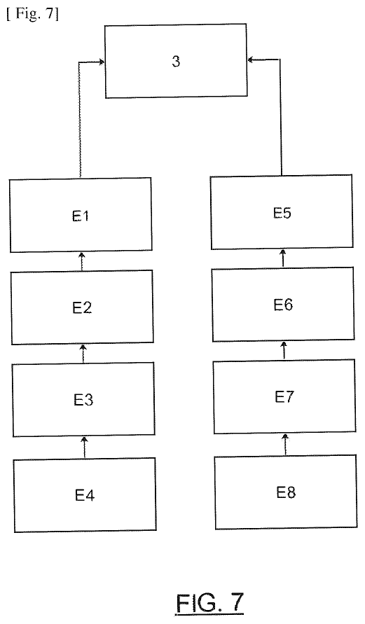

According to the invention, the fuel cell 2 comprises a first electrochemical line LA and a second electrochemical line LB electrically connected in parallel, each electrochemical line LA, LB comprising four independent stacks E1-E4, E5-E8 electrically connected in series as illustrated in FIG. 7.

The presence of at least two electrochemical lines LA, LB electrically connected in parallel advantageously enables them to be supplied in different ways in order to regulate power natively, i.e., without using an electronic power regulation device. The presence of at least two independent stacks E1-E4, E5-E8, electrically connected in series, in an electrochemical line LA, LB, advantageously provides high electrical power while allowing for easy maintenance due to its modularity.

This advantageously allows the fuel cell 2 to be optimally sized to have a wide operating range without requiring a heavy and bulky electronic power regulation device. The modular structure of the fuel cell 2 thus allows to form a power supply system 1 with a high power density by mass and volume, which is advantageous in an aeronautical context.

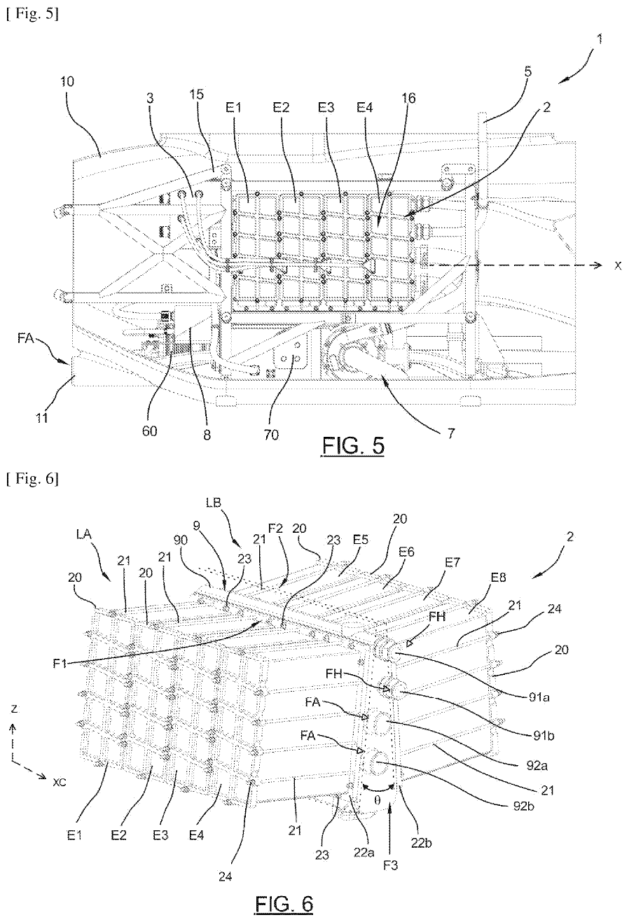

Referring to FIG. 6, the fuel cell 2 comprises a manifold 9 to which the stacks E1-E8 are connected. The manifold 9 is supplied by the air flow FA and hydrogen flow FH to supply each electrochemical line LA, LB.

With reference to FIG. 6, the manifold 9 extends longitudinally along a manifold axis XC and vertically along a vertical axis Z. The manifold 9 has a body 90 comprising a first lateral face F1 configured to interface with the stacks E1-E4 of the first electrochemical line LA and a second lateral face F2 configured to interface with the stacks E5-E8 of the second electrochemical line LB. In this example, with reference to FIG. 6, the first lateral face F1 and the second lateral face F2 are inclined with respect to each other by a spread angle θ so that the manifold 9 is flared at the lower part. Preferably, the fuel cell 2 is V-shaped. Preferably, the spread angle θ is between 2° and 90°, preferably between 2° and 10°. This has the advantage of allowing residues from the electrochemical reactions in stacks E1-E8, such as water, to be recovered by gravity in the manifold 9, while taking up limited space. This type of architecture also allows improvement in the structural integrity. The use of a manifold 9 allows several low-height stacks E1-E8 to be used in the same electrochemical line. The offset mass, i.e. the mass of the cantilevered stacks E1-E8, is therefore lower, which limits eigenmodes in high-frequency vibration.

The manifold 9 further comprises a connection face F3 which is preferably located downstream in order to connect to the air supply circuit 7 and the hydrogen supply circuit 5. As illustrated in FIG. 6, the connection face F3 comprises a hydrogen inlet connector 91a configured to supply all the stacks E1-E8, a hydrogen outlet connector 91b, an air inlet connector 92a configured to supply the stacks E1-E8 and an air outlet connector 92b.

Alternatively, the connection face F3 could comprise:
a first hydrogen connector configured to supply the stacks E1-E4 of the first lateral face F1,
a second hydrogen connector configured to supply the stacks E5-E8 on the second lateral face F2,
a first air connector configured to supply the stacks E1-E4 of the first lateral face F1 and
a second air connector configured to supply the stacks E5-E8 on the second lateral face F2.

According to this aspect, each electrochemical line LA, LB is independently supplied with air flow FA and hydrogen flow FH. Advantageously, the manifold 9 comprises independent internal ducts for supplying each electrochemical line LA, LB.

Preferably, the power supply system 1 includes an air control valve (not shown), preferably associated with each electrochemical line LA, LB, so as to regulate the power in the fuel cell 2 without resorting to an electronic power regulation device.

Even more preferably, the power supply system 1 includes a hydrogen control valve (not shown), preferably associated with each electrochemical line LA, LB, so as to regulate the power in the fuel cell 2 without recourse to an electronic power regulation device.

Preferably, still with reference to FIG. 6, the hydrogen connectors 91a, 91b are located vertically above the air connectors 92a, 92b so as to segregate as much as possible the hydrogen flow FH in the upper part and the air flow FA in the lower part of the power supply system 1. Since the hydrogen is lighter than air, it separates from the air in the event of a leak, allowing for appropriate treatment.

As shown in FIGS. 6, 8 and 9, the fuel cell 2 has a modular structure to facilitate maintenance.

In this example, the first lateral face F1 is connected to a first common end plate 22a to which all the stacks E1-E4 supplied by said first lateral face F1 are connected, i.e., the stacks E1-E4 of the first electrochemical line LA. In a similar way, the second lateral face F2 is connected to a second common end plate 22b to which all the stacks E5-E8 supplied by said second lateral face F2 are connected, i.e., the stacks E5-E8 of the second electrochemical line LB.

Preferably, each common end plate 22a, 22b comprises supply openings for each stack E1-E8. Advantageously, a flat seal may be used with each common end plate 22a, 22b, which improves leak tightness compared to a hydraulic/pneumatic connection. Advantageously, since each common end plate 22a, 22b rests against the body 90 of the manifold 9, each common end plate 22a, 22b may inherently have a smaller mass and volume than a traditional end plate, since it may benefit from the rigidity of the body 90 of the manifold 9 to which it is connected.

As illustrated in FIG. 6, each common end plate 22a, 22b is detachably connected to a lateral face F1, F2 of the body 90 of the manifold 9, in particular, by connecting members 23 such as screws or the like. Advantageously, this enables an entire electrochemical line LA, LB to be removed from the fuel cell 2 simply by dismantling a common end plate 22a, 22b, as will be shown later.

Each stack E1-E4 supplied by said first lateral face F1 is independently connected to the first common end plate 22a. Similarly, each stack E5-E8 supplied by said second lateral face F2 is independently connected to the second common end plate 22b. In this example, as illustrated in FIG. 6, each stack E1-E8 is held between a personal end plate 20 and a common end plate 22a, 22b by a plurality of traction members 21 called “tie rods”. A traction member 21 may take the form of a threaded rod, for example. In this example, the traction members 21 are connected to the personal end plate 20 by fasteners 24, e.g. nuts.

This allows a stack E1-E8 to be removed by removing the personal end plate 20 from said stack E1-E8, without removing the common end plates 22a, 22b, and allows the other stacks to continue to be compressed in a sealed manner. Preferably, the plurality of traction members 21 are secured to the common end plate 22a, 22b. Thus, an operator only needs to act on the fasteners 24 that are accessible to perform a removal.

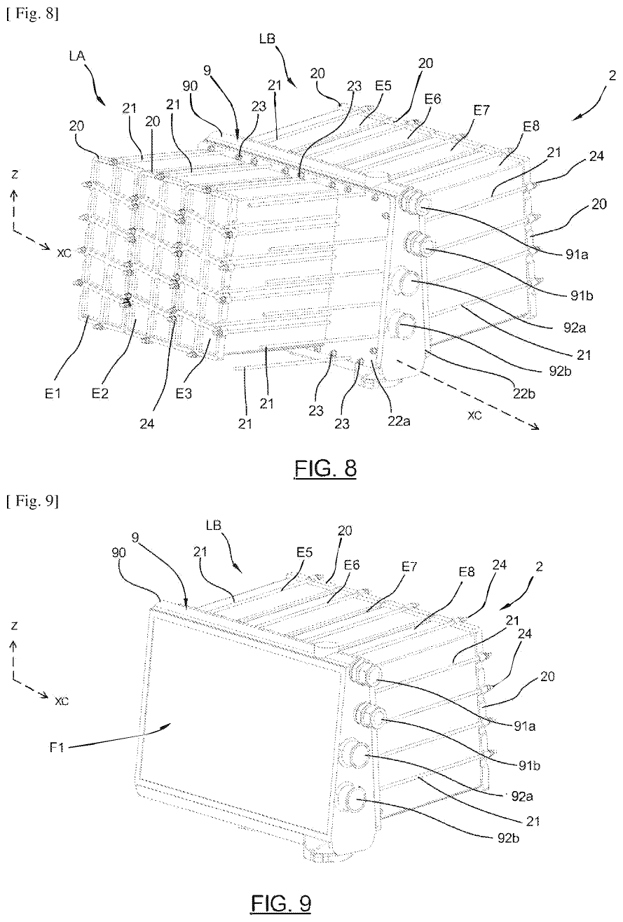

With reference to FIG. 8, an example of the implementation of a method for dismantling a single stack E4 will be presented. The method includes a step consisting in removing the personal end plate 20 holding said stack E4 so as to allow its removal. In practice, it is sufficient to remove the fasteners 24 associated with the personal end plate 20 to release the stack E4. The stack E4 may be moved away from the manifold 9 and its lateral face F1. A new stack may then be conveniently and quickly installed without affecting the tightness of the other stacks, which is highly advantageous. The personal end plate 20 is then positioned and locked in position by the fasteners 24 mounted on the traction members 21.

With reference to FIG. 9, an example of a method for dismantling all the stacks E1-E4 of the first electrochemical line LA will be presented. The disassembly method includes a step of removing the first common end plate 22a by removing the connecting members 23. As the stacks E1-E4 are held between the first common end plate 22a and their personal end plates 20, they may be handled together.

This enables rapid removal to replace the stacks E1-E4 without removing each personal endplate 20 individually. A new first common end plate associated with several new stacks may then be set up quickly and conveniently.

Referring to FIG. 3, the electrical distribution unit 3 is electrically connected to the fuel cell 2. In this example, the electrical distribution unit 3 comprises a plurality of electrical connectors 30 for directly connecting propelling electric motors M.

According to a preferred aspect of the invention, the electrical distribution unit 3 does not include any electronic power control device. As a result, there are no power members such as converters, especially DC/DC converters, required to adapt the power supplied to the propelling electric motors M as in the prior art. Preferably, the electrical distribution unit 3 has no electrical batteries.

Referring to FIG. 6, as previously shown, the fuel cell 2 comprises air connectors 92a, 92b in a lower part and hydrogen connectors 91a, 91b in an upper part. This allows the segregation of air and hydrogen within the enclosure 10. As shown in FIGS. 3 to 4, the air supply circuit 7 is positioned in a lower part of the enclosure 10, while the hydrogen supply circuit 5 is positioned in an upper part of the enclosure 10 to increase the segregation. Similarly, the cooling circuit 6 is positioned in a lower part of the enclosure 10.

As previously shown, the air connectors 92a, 92b and the hydrogen connectors 91a, 91b are positioned at the downstream end of the fuel cell 2, while the electrical distribution unit 3 is mounted upstream of the fuel cell 2, in particular upstream of the main housing 16. This allows the fuel supply to electrical equipment to be shut off, reducing the risk of accidents. The electrical members connected to the air supply circuit 7 and the cooling circuit 6 (including pumps) are also mounted upstream of the fuel cell 2. Thus, a segregation is achieved within the enclosure between the electrical members and the fuels, which improves safety.

The hydrogen connectors 91a, 91b are positioned at the upper part of the downstream end so that the hydrogen supply circuit 5 has a reduced length. Such a hydrogen supply circuit 5 is expensive, as it requires a high degree of safety.

Furthermore, the use of common terminal plates 22a, 22b and a manifold 9 allows the reduction of hydrogen leakage paths (two paths for common terminal plates 22a, 22b and two paths for hydrogen connectors 91 a, 91 b) for 8 stacks E1-E8, which is low compared to the prior art, which required two leakage paths per stack (one terminal plate and one hydrogen connector).

With reference to FIG. 2, the cooling circuit 6 is configured to circulate a cooling fluid FR in the fuel cell 2, in particular in a closed loop. The cooling circuit 6 comprises a cooling circulation pump 60 for driving the cooling fluid FR. In this example, the cooling circulation pump 60 is positioned vertically below the fuel cell 2 so as to keep it away from the hydrogen supply circuit 5, which is routed from an upper part.

In this example, with reference to FIG. 2, the cooling circuit 6 includes a heat exchanger 61 for removing heat collected by the cooling fluid FR in the fuel cell 2. As shown in FIG. 4, the enclosure 10 comprises an auxiliary air orifice 13 to allow the admission of a cooling air flow FAR configured to collect heat from the heat exchanger 61. Preferably, the enclosure 10 comprises two auxiliary air inlet orifices 13 positioned on opposite side walls of the enclosure 10.

With reference to FIG. 2, the air supply circuit 7 is configured to supply the fuel cell 2 with an air flow FA. The air supply circuit 7 comprises an upstream air inlet 11 formed in the enclosure 10. The air supply circuit 7 includes an air circulation pump 70 for compressing the FA air flow to a pressure compatible with the fuel cell 2. In this example, the air circulation pump 70 is positioned vertically below the fuel cell 2 so as to distance it from the hydrogen supply circuit 5, which is routed from an upper part.

With reference to FIG. 2, the power supply system 1 further comprises an auxiliary electrical box 8 configured to electrically supply the air circulation pump 70 and the cooling circulation pump 60. The auxiliary electrical box 8 is powered by the electrical distribution unit 3 or by the fuel cell 2.

An example of a method for powering several propelling electric motors M connected directly to the electrical distribution unit 3 of a power supply system 1.

The method of use includes a step of supplying each emission line LA, LB of the fuel cell 2 with an air flow FA and a hydrogen flow FH. The air flow FA is supplied from a lower part of the enclosure 10, while hydrogen flow FH is supplied from an upper part of the enclosure 10. Each electrochemical line LA, LB is independently supplied and regulated with air flow FA and hydrogen flow FH to provide power adapted to the flight phase of the propelling electric motor M.

The electrical distribution unit 3 collects power on each electrochemical line LA, LB to directly power the propelling electric motors M, i.e., without using an electronic power regulation device. Advantageously, the auxiliary electrical box 8 draws the power from the electrical distribution unit 3 to supply the pumps 60, 70 of the cooling circuit 6 and the air supply circuit 7.

1-8. (canceled)

9. A manifold for a fuel cell configured to be supplied with an air flow and with a hydrogen flow, the fuel cell comprising at least two stacks, each stack comprising a plurality of electrochemical cells, the manifold extending longitudinally along a manifold axis and vertically along a vertical axis, the manifold defining a body comprising a first lateral face configured to interface with at least one stack and a second lateral face configured to interface with at least one stack, the first lateral face and the second lateral face being inclined with respect to each other by a spread angle so that the body of the manifold is flared at the lower part, the manifold comprising a connection face comprising:
a first hydrogen connector configured to supply said at least one stack from the first lateral face,
a first air connector configured to supply said at least one stack from the first lateral face.

10. The manifold according to claim 9, wherein each lateral face is connected to a common end plate to which all the stacks interfaced with said lateral face are connected.

11. The manifold according to claim 10, wherein the common end plate is removably connected to said lateral face.

12. The manifold according to claim 10, wherein each stack interfaced with a lateral face is independently connected to the common end plate associated with said lateral face.

13. The manifold according to claim 10, wherein each stack interfaced with said lateral face comprises a personal end plate connected to the common end plate by a plurality of traction members.

14. A fuel cell characterized in that it comprises a manifold according to claim 9 configured to be supplied by the air flow and the hydrogen flow and at least two stacks connected to the manifold, each stack comprising a plurality of electrochemical cells.

15. A method of maintaining a manifold according to claim 10, each lateral face being connected to a common end plate to which all the stacks interfaced with said lateral face are connected, the method comprising a step consisting in:
removing a common end plate from the body of the manifold, with all the stacks supplied by the lateral face associated with the common end plate remaining secured to the common end plate.

16. A method of maintaining a manifold according to claim 13, each lateral face being connected to a common end plate to which all the stacks interfaced with said lateral face are connected, each stack interfaced with said lateral face comprising a personal end plate connected to the common end plate by a plurality of traction members, the method comprising steps consisting in:
removing a personal end plate from a stack,
removing the stack from a common end plate,
placing a new stack on the common end plate, and
replacing the personal end plate on the new stack.
